(19) United States
(12) Patent Application Publication
(10) Pub. No.: US 2010/0254400 A1
(43) Pub. Date: Oct. 7, 2010

(54) METHOD AND APPARATUS FOR ALLOWING TRANSMISSION DELAY IN HOME AGENT OF MOBILE IP NETWORK

(75) Inventors: Myung Ki Shin, Daejeon (KR); Yong-Woon Kim, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/743,698

(22) PCT Filed: Jul. 29, 2008
(86) PCT No.: PCT/KR08/04401

§ 371 Date: May 19, 2010

(30) Foreign Application Priority Data
Nov. 19, 2007 (KR) 10-2007-0117734

(51) Int. Cl. H04L 12/54

(52) U.S. Cl. 370/428

(57) ABSTRACT

A method and apparatus for allowing transmission delay in a mobile Internet Protocol (IP) network is provided. The method of allowing transmission delay in a home agent of a mobile IP network, the method including: storing data in a mobile router when disconnection with the mobile router is sensed; and transmitting the stored data to the mobile router when reconnection with the mobile router is sensed.

### TECHNICAL FIELD

The present invention relates to a method and apparatus for allowing transmission delay in a mobile Internet Protocol (IP) network, and more particularly, to a method and apparatus for allowing transmission delay which, when communication with a mobile network communicating in a mobile IP network is disconnected, stores data in the mobile network in a storage until the communication is restored.

This work was supported by the IT R&D of MIC/IITA.

### BACKGROUND ART

A mobile Internet Protocol (IP) transmission scheme is a technology enabling a mobile node (MN) to connect to the Internet via an Internet node of another network without changing an IP address. The mobile IP transmission scheme is developed by a working group of Internet Engineering Task. Force (IETF). To guarantee mobility of MN is critical in the mobile IP technology. Currently, in a method of guaranteeing mobility of a single MN in a standardized mobile IP environment, every time a current location of the MN, that is, an address of a subnet where the MN is currently located, changes, the MN registers the change of the address of the subnet, that is, Care of Address (COA), in a home agent (HA). The method of guaranteeing is applied to all MNs. Specifically, the method of guaranteeing may be applied to an MN in a moving object.

However, an MN in a mobile object may move to another subnet faster than an MN which moves at walking speed, and a handoff or roaming occurs more frequently. To overcome such disadvantages, a concept of Network Mobility (NEMO) is used in a mobile IP. Accordingly, an MN communicating with a mobile router (MR) may be provided with a communication service using an MR without a change of subnet address when moving.

FIG. 1 is a diagram illustrating a configuration of a mobile Internet Protocol (IP) network including a mobile network in a conventional art. Referring to FIG. 1, the mobile IP network in the conventional art includes a home agent (HA) 100, corresponding node (CN) 110, foreign agents (FAs) 120 and 130, and mobile network (MONET) 140. The MONET 140 includes a mobile router (MR) 150 communicating with mobile nodes (MNs) 162, 164, 166, and 168.

In a method of supporting mobility of a mobile IP network in the conventional art, when passing an area t1 while the MONET 140 moves from an area t0 to an area t2, the MONET 140 is disconnected with the external Internet. Accordingly, data transmitted from the CN 110 while disconnected may not be received. In this instance, the area t0 is a subnet domain of the first FA 120, the area t1 is an area where external Internet connectivity is disconnected, and the area t2 is a subnet domain of the second FA 130. Also, the MONET 140 sets up a tunnel with the HA 100 and communicates with the HA 100.

A transmission method of a Delay Tolerant Network (DTN) in a conventional art is mainly suggested for interplanetary data communication. Since the connectivity of among planets is uncertain as opposed to an existing IP communication scheme, data is asynchronously transmitted in a store-and-forward manner. For this, data is encapsulated as a bundle message, and the encapsulated data is transmitted. A detailed description of the DTN may be obtained by referring to the Delay Tolerant Network Architecture published by a DTN research group in May 2003.

### DISCLOSURE OF INVENTION

### Technical Goals

The present invention provides a method and apparatus for allowing transmission delay in a mobile Internet Protocol (IP) network.

The present invention also provides a method and apparatus for allowing transmission delay in a network which, when communication with a mobile network communicating in a mobile IP network is disconnected, stores data in the mobile network in a storage until the communication is restored.

The present invention also provides a method and apparatus for allowing transmission delay which, when communication with a mobile network communicating in a mobile IP network is disconnected, stores data to the mobile network until the communication is restored, and when the communication is restored, transmits the stored data to the mobile network as a bundle message.

The present invention also provides a method and apparatus for allowing transmission delay which, when a mobile node communicating in a mobile router of a mobile IP network is in a sleep state, stores transmission data to the mobile node until the sleep state is released, and transmits the stored data to the mobile network as a bundle message when the sleep state is released.

The present invention is not limited to the above-described technical goals, and other technical goals which have not been described above may be understood by those skilled in the related arts.

### Technical Solutions

According to an aspect of the present invention, there is provided a method of allowing transmission delay in a home agent of a mobile Internet Protocol (IP) network, the method including: storing data in a mobile router when disconnection with the mobile router is sensed; and transmitting the stored data in the mobile router when reconnection with the mobile router is sensed.

According to another aspect of the present invention, there is provided a method of allowing transmission delay in a mobile router of a mobile IP network, the method including: storing data in a mobile node when a sleep mode of the mobile node is sensed; and transmitting the stored data in the mobile node when the mobile node wakes up.

According to still another aspect of the present invention, there is provided an apparatus for allowing transmission delay in a mobile IP network, the apparatus including: a home agent storing data in a mobile router in a home storage when disconnection with the mobile router is sensed, and transmitting the stored data in the mobile router when reconnection with the mobile router is sensed; and the home storage storing the data in the mobile router according to a control of the home agent.

According to yet another aspect of the present invention, there is provided an apparatus for enabling transmission delay in a mobile IP network, the apparatus including: a mobile router storing data in a mobile node in a router storage when a sleep mode of the mobile node is sensed, and transmitting the stored data in the mobile node when the mobile node wakes up; and the router storage storing the data in the mobile node according to a control of the mobile router.

### BRIEF DESCRIPTION OF DRAWINGS

FIG. 1 is a diagram illustrating a configuration of a mobile Internet Protocol (IP) network including a mobile network in a conventional art;

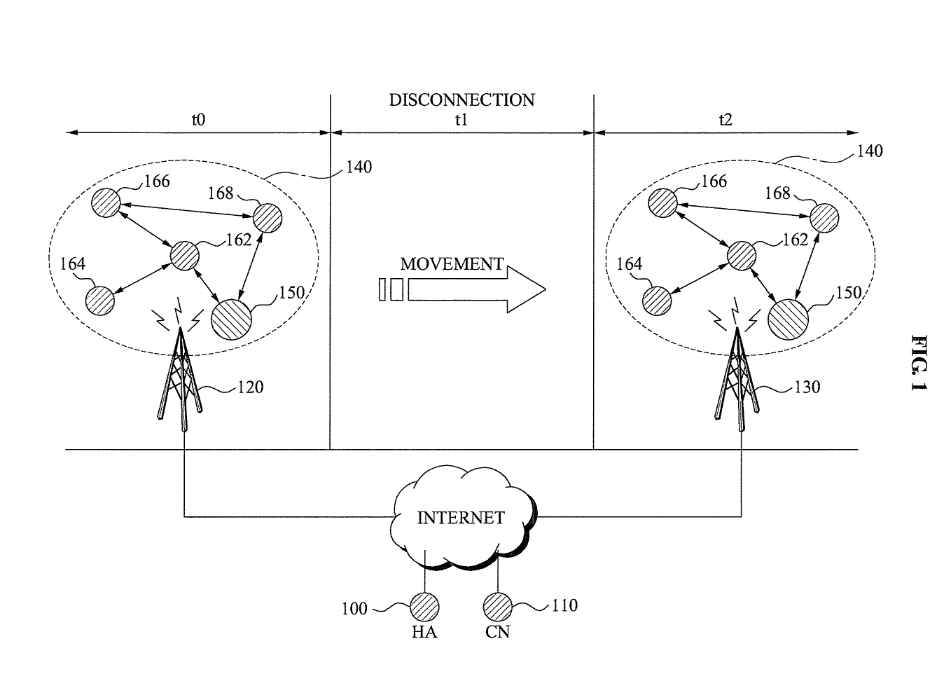

FIG. 2 is a diagram illustrating a configuration of a mobile IP network allowing transmission delay according to an embodiment of the present invention;

FIG. 3 is a flowchart illustrating a method of allowing transmission delay in a home agent of a mobile IP network according to an embodiment of the present invention; and

FIG. 4 is a flowchart illustrating a method of allowing transmission delay in a mobile router of a mobile IP network according to an embodiment of the present invention.

### BEST MODE FOR CARRYING OUT THE INVENTION

Hereinafter, embodiments of the present invention are described in detail by referring to the figures.

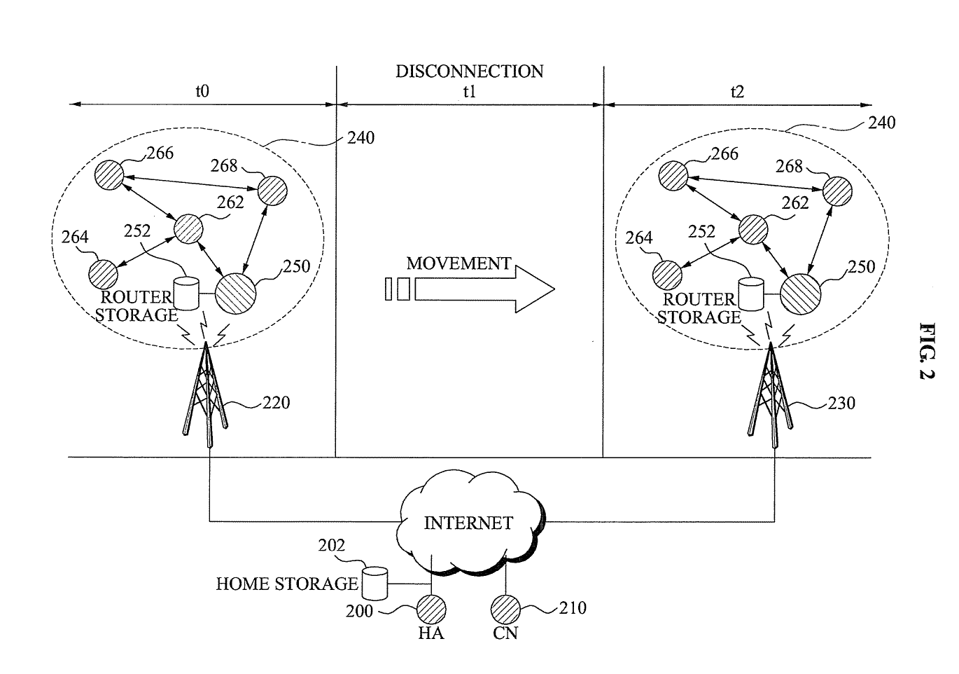

The present invention relates to a method and apparatus for allowing transmission delay in a network which, when communication with a mobile network communicating in a mobile Internet Protocol (IP) network is disconnected, stores data in the mobile network in a storage until the communication is restored. Hereinafter, a mobile IP network according to the present invention is described in detail with reference to FIG. 2.

FIG. 2 is a diagram illustrating a configuration of a mobile IP network allowing transmission delay according to an embodiment of the present invention. Referring to FIG. 2, the mobile IP network includes a home agent (HA) 200 including a home storage 202, corresponding node (CN) 210, foreign agents (FAs) 220 and 230, and mobile network (MONET) 240. The MONET 240 includes a router storage 252 and mobile nodes (MNs) 262, 264, 266, and 268 communicate with each other.

The HA 200 confirms whether communication with a mobile router (MR) 250 is disconnected. When the communication is disconnected as a result of the confirming, data in the disconnected MR 250 is stored in home storage 202. When the communication with the disconnected MR 250 is restored, the stored data is encapsulated as a bundle message and transmitted to the MR 250. The bundle message is defined in a Delay Tolerant Network (DTN). The home storage 202 may be configured as an internal or external apparatus of the HA 200.

When communication which has been disconnected due to movement to an area where communication is impossible is restored, the MR 250 receives data which has not been received due to the disconnection from the HA 200 as a bundle message.

Also, the MR 250 confirms whether the MNs 262, 264, 266, and 268 are in a sleep state. Also, the MR 250 stores, in the router storage 252, data in a corresponding MN in the sleep state. When it is sensed that the sleep state is terminated, the MR 250 encapsulates the stored data in the corresponding MN as a bundle message, and transmits the encapsulated data in the corresponding MN. The bundle message is defined in the DTN. In this instance, the router storage 252 may be configured as an internal or external apparatus of MR 250.

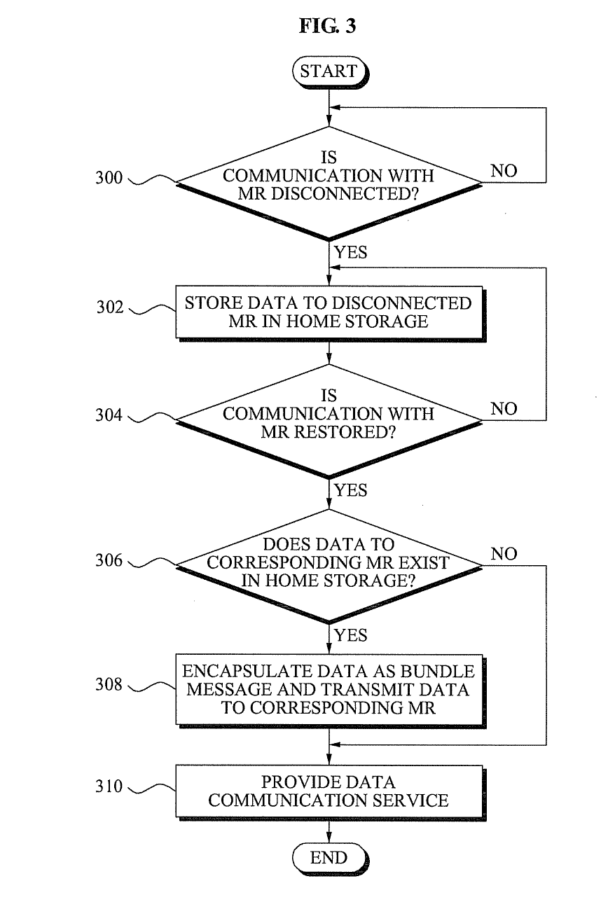

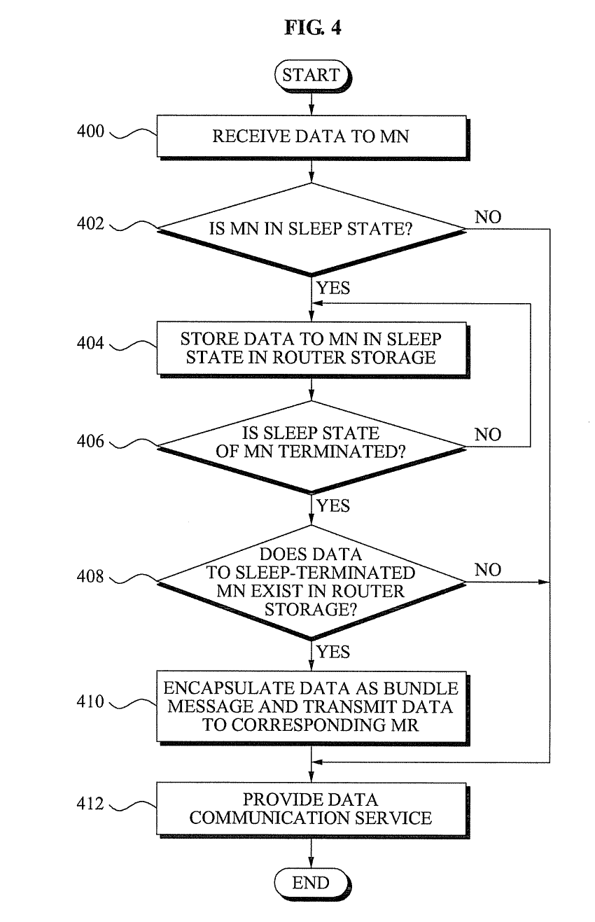

Hereinafter, a method of allowing transmission delay in a mobile IP network according to an embodiment of the present invention is described in detail with reference to FIGS. 3 and 4.

FIG. 3 is a flowchart illustrating a method of allowing transmission delay in a home agent of a mobile IP network according to an embodiment of the present invention. Referring to FIG. 3, in operation 300, a HA confirms whether communication with an MR is disconnected. Specifically, when an error message such as an Internet Control Message Protocol (ICMP) error is received according to a general Internet communication method, it is determined that the communication is disconnected. The error message indicates that communication may not be performed.

When it is sensed that the communication is disconnected according to a result of the confirming in operation 300, the HA stores data to the disconnected MR in a home storage in operation 302, and confirms whether the communication with the MR is restored in operation 304. In operation 304, when a binding update (BU) message is received from the MR and a tunnel is set, it is determined that the communication is restored.

When the communication is not restored as a result of the confirming in operation 304, the HA returns to operation 302, and continuously stores the data in the MR in the home storage. When it is sensed that the communication is restored as a result of the confirming in operation 304, the HA confirms whether the data in the MR where the communication is restored exists in the home storage in operation 306. When the data in the MR does not exist in the home storage as a result of the confirming in operation 306, the HA provides a general data communication service in operation 310.

However, when the data in the MR exists in operation 306, the HA encapsulates the stored data as a bundle message and transmits the encapsulated data to the MR. Also, the HA provides the general data communication service in operation 310. The bundle message is defined in a DTN.

FIG. 4 is a flowchart illustrating a method of allowing transmission delay in a mobile router of a mobile IP network according to an embodiment of the present invention. Referring to FIG. 4, when data to an MN which is communicating is received in operation 400, an MR confirms whether the MN is in a sleep state in operation 402. To maintain connectivity between the MN and MR in a general mobile IP, connectivity in Internet Protocol version 4 (IPv4) is maintained through an Address Resolution Protocol (ARP) and connectivity in IPv6 is maintained through a Neighbor Discovery Protocol (NDP). In operation 402, to confirm whether the MN is in the sleep state, it is confirmed whether the ARP, NDP, and the like are periodically transmitted/received. When the ARP, NDP, and the like are not periodically transmitted/received, it is determined that the MN is in the sleep state.

When the MN is not in the sleep state as a result of the confirming in operation 402, the MR provides a general data communication service in operation 412. When the MN is in the sleep state as a result of the confirming in operation 402, the MR stores data in the MN in the sleep state in a router storage in operation 404, and confirms whether the sleep state of the MN is terminated in operation 406. When the MN is in the sleep state as a result of the confirming in operation 406, the MR returns to operation 404, and continuously stores the data in the MN.

When it is sensed that the sleep state of the MN is terminated as a result of the confirming in operation 406, the MR confirms whether the data to the MN exists in a router storage in operation 408. When the data exists in the router storage, the MR encapsulates the stored data as a bundle message and transmits the encapsulated data to the MR in operation 410. Also, the MR provides the general data communication service in operation 412. The bundle message is defined in a DTN.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A method of allowing transmission delay in a home agent of a mobile Internet Protocol (IP) network, the method comprising:
storing data in a mobile router when disconnection with the mobile router is sensed; and
transmitting the stored data in the mobile router when reconnection with the mobile router is sensed.

2. The method of claim 1, wherein the transmitting encapsulates the stored data as a bundle message defined in a Delay Tolerant Network (DTN), and transmits the encapsulated data to the mobile router.

3. The method of claim 1, wherein the disconnection with the mobile router is sensed when an error message indicating communication is not available according to an Internet Control Message Protocol (ICMP) is received.

4. The method of claim 1, wherein the reconnection with the mobile router is sensed when a binding update (BU) message is received from the mobile router and a bidirectional communication tunnel is set.

5. A method of allowing transmission delay in a mobile router of a mobile IP network, the method comprising:
storing data in a mobile node when a sleep mode of the mobile node is sensed; and
transmitting the stored data in the mobile node when the mobile node wakes up.

6. The method of claim 5, wherein the transmitting encapsulates the stored data as a bundle message defined in a DTN, and transmits the encapsulated data to the mobile node.

7. The method of claim 5, wherein the sleep mode of the mobile node is sensed when whether the mobile router and the mobile node transmit/receive a message is periodically confirmed through an Address Resolution Protocol (ARP) or Neighbor Discovery Protocol (NDP), and the message is not transmitted/received.

8. An apparatus for allowing transmission delay in a mobile IP network, the apparatus comprising:
a home agent storing data in a mobile router in a home storage when disconnection with the mobile router is sensed, and transmitting the stored data in the mobile router when reconnection with the mobile router is sensed; and
the home storage storing the data in the mobile router according to a control of the home agent.

9. The apparatus of claim 8, wherein the home agent encapsulates the stored data as a bundle message defined in a DTN, and transmits the encapsulated data to the mobile router.

10. The apparatus of claim 8, wherein the home agent senses the disconnection when an error message indicating communication is not available according to an ICMP is received.

11. The apparatus of claim 8, wherein the home agent senses the reconnection when a BU message is received from the mobile router and a bidirectional communication tunnel is set.

12. An apparatus for enabling transmission delay in a mobile IP network, the apparatus comprising:
a mobile router storing data in a mobile node in a router storage when a sleep mode of the mobile node is sensed, and transmitting the stored data in the mobile node when the mobile node wakes up; and
the router storage storing the data in the mobile node according to a control of the mobile router.

13. The apparatus of claim 12, wherein the mobile router encapsulates the stored data as a bundle message defined in a DTN, and transmits the encapsulated data to the mobile node.

14. The apparatus of claim 12, wherein the mobile router senses the sleep mode of the mobile node, when whether the mobile router and the mobile node transmit/receive a message is periodically confirmed through an ARP or NDP, and the message is not transmitted/received.
